(19) United States
(12) Patent Application Publication
(10) Pub. No.: US 2026/0060175 A1
(43) Pub. Date: Mar. 5, 2026

(54) SYSTEM AND METHOD FOR AN AGRICULTURAL HARVESTER

(71) Applicant: CNH Industrial Brasil Ltda., Nova Lima (BR)

(72) Inventors: João Augusto Marcolin Lucca, Piracicaba-SP (BR); Daenio Cleodolphi, Piracicaba-SP (BR); Marcos Ikeguchi Ohira, Piracicaba-SP (BR); Marco Aurélio Ramos Pereira, Piracicaba-SP (BR); Gilberto José Ribeiro Alves, Piracicaba-SP (BR)

(21) Appl. No.: 19/105,993

(22) PCT Filed: Aug. 29, 2023
(86) PCT No.: PCT/BR2023/050287

§ 371 Date: Feb. 24, 2025

(30) Foreign Application Priority Data
Aug. 31, 2022 (BR) 1020220174644

(51) Int. Cl. A01D 41/127; A01D 43/08; A01D 45/10

(52) U.S. Cl. CPC A01D 41/1271; A01D 43/085; A01D 45/10

(57) ABSTRACT

A system for an agricultural harvester includes a material processing system configured to receive a flow of harvested materials. A first sensor assembly is configured to capture data associated with a first mass flow rate. A second sensor assembly is configured to capture data associated with a second mass flow rate. A computing system is communicatively coupled to the first and second sensors. The computing system is configured to determine a first mass flow rate of the flow of the harvested materials based at least in part on the data received from the first sensor assembly, determine a second mass flow rate of the flow of the harvested materials based at least in part on the data received from the second sensor assembly, and determine an error between the first mass flow rate and the second mass flow rate.

### FIELD OF THE INVENTION

The present disclosure relates generally to agricultural harvesters, such as sugarcane harvesters, and, more particularly, to systems and methods for monitoring the operational conditions of the agricultural harvester.

### BACKGROUND OF THE INVENTION

Agricultural harvesters can include an assembly of processing equipment for processing harvested crop materials. For instance, within a sugarcane harvester, severed sugarcane stalks are conveyed via a feed roller assembly to a chopper assembly that cuts or chops the sugarcane stalks into pieces or billets (e.g., six-inch cane sections). The processed crop material discharged from the chopper assembly is then directed as a stream of billets and debris into a primary extractor, within which the airborne debris (e.g., dust, dirt, leaves, etc.) is separated from the sugar billets. The separated/cleaned billets then fall into an elevator assembly for delivery to an external storage device.

During the operation of the harvester, it may be desirable to monitor the crop yield as the machine goes through the field. Accordingly, systems and methods for monitoring the crop yield for an agricultural harvester that address one or more issues associated with existing systems/methods would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to a system for an agricultural harvester. The system includes a material processing system configured to receive a flow of harvested materials. A first sensor assembly is operably coupled with the material processing system and is configured to capture data associated with a first mass flow rate. A second sensor assembly is operably coupled with the material processing system and is configured to capture data associated with a second mass flow rate. A computing system is communicatively coupled to the first sensor assembly and the second sensor assembly. The computing system is configured to determine the first mass flow rate of the flow of the harvested materials through the material processing system based at least in part on the data received from the first sensor assembly: determine the second mass flow rate of the flow of the harvested materials through the material processing system based at least in part on the data received from the second sensor assembly; and determine an error between the first mass flow rate and the second mass flow rate.

In some aspects, the present subject matter is directed to a method for operating an agricultural harvester. The agricultural harvester includes a material processing system configured to receive a flow of harvested materials. The method includes determining, with a computing system, a first mass flow rate of the flow of the harvested materials directed through the material processing system based on data received from a first sensor assembly; determining, with the computing system, a second mass flow rate of the flow of the harvested materials directed through the material processing system based on data received from a second sensor assembly; and determining an error between the first mass flow rate of the flow of the harvested materials and the second mass flow rate of the flow of the harvested materials.

In some aspects, the present subject matter is directed to a system for an agricultural harvester. The system includes a material processing system configured to receive a flow of harvested materials. A first sensor assembly is operably coupled with the material processing system and is configured to capture data associated with a first mass flow rate. A second sensor assembly is operably coupled with the material processing system and is configured to capture data associated with a second mass flow rate. A computing system is communicatively coupled to the first sensor assembly and the second sensor assembly. The computing system is configured to determine the first mass flow rate of the flow of the harvested materials through the material processing system based at least in part on the data received from the first sensor assembly; determine the second mass flow rate of the flow of the harvested materials through the material processing system based at least in part on the data received from the second sensor assembly; determine an error between the first mass flow rate and the second mass flow rate; and determine a first factor for correlating the second mass flow rate to the first mass flow rate during a calibration process.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of an agricultural harvester in accordance with aspects of the present subject matter;

FIG. 2 is a bottom plan view of a first sensor assembly configured as a weigh pad and transducer for use with the harvester in accordance with aspects of the present subject matter;

FIG. 3 is a side elevational view of the weigh pad and transducer arrangement of the first sensor assembly for use with the harvester in accordance with aspects of the present subject matter;

FIG. 4 illustrates a side view of a portion of a material processing system of the agricultural harvester incorporating a second sensor assembly in accordance with aspects of the present subject matter;

FIGS. 5A and 5B illustrate a detailed view of a top roller of a feed roller assembly of an agricultural harvester in accordance with aspects of the present subject matter;

FIG. 6 illustrates a schematic view of a system for an agricultural harvester in accordance with aspects of the present subject matter;

FIG. 7 illustrates a graph of a first mass flow rate as detected by the first sensor assembly, a second mass flow rate as detected by the second sensor assembly, and an error between the first mass flow rate and the second flow rate in accordance with aspects of the present subject matter; and

FIG. 8 illustrates a flow diagram of a method for operating the agricultural harvester in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a crop within a fluid circuit. For example, “upstream” refers to the direction from which a crop flows, and “downstream” refers to the direction to which the crop moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for monitoring an operation of an agricultural harvester. In several embodiments, a computing system is communicatively coupled to a first sensor assembly and a second sensor assembly that each capture data associated with the materials being directed through a material processing system of a harvester. Such data may, in turn, be used by the computing system to monitor the crop yield of the harvester, such as by allowing the computing system to calculate or determine a first mass flow rate of the harvested materials directed through the material processing system of the harvester based on the first sensor assembly and/or a second mass flow rate of the harvested materials directed through the material processing system of the harvester based on the sensor assembly.

In addition to monitoring the crop yield based on the data, the computing system may also be configured to initiate or execute one or more control actions associated with the monitored crop yield. For example, the control actions may include generating a notification when an error between the first mass flow rate and the second mass flow rate exceeds a defined threshold, possibly for a predefined amount of time. Additionally or alternatively, the one or more control actions may include recalibrating the calculated mass flow rate of the first sensor assembly based on the data from the second sensor assembly and/or recalibrating the calculated mass flow rate of the second sensor assembly based on the data from the first sensor assembly. Furthermore, the one or more control actions may include controlling one or more harvester components based at least in part on the first mass flow rate and/or the second mass flow rate.

The presently disclosed system and method generally provide numerous advantages for monitoring the crop yield of the harvester. For instance, cane harvesters can operate in dirty or muddy environments and, thus, may be subject to periodic maintenance operations and/or cleaning operations (e.g., using high pressure liquid jets) to dislodge dirt, mud, and extraneous matter which tends to accumulate proximate the first sensor assembly. The system and methods provided herein may be capable of generating notifications for a user of suggested maintenance based on the first sensor assembly and/or the second sensor assembly. In addition, the system may be capable of recalibrating itself leading to less downtime for maintenance.

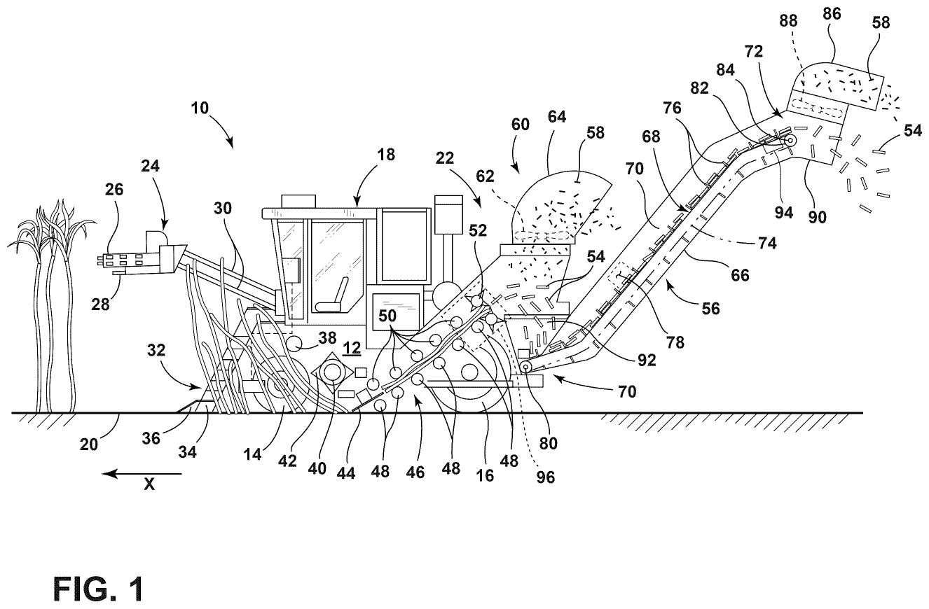

Referring now to the drawings, FIG. 1 illustrates a side view of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame 12, a pair of front wheels 14, a pair of rear wheels 16, and an operator's cab 18. The harvester 10 may also include a source of power (e.g., an engine mounted on the frame 12) which powers one or both pairs of the wheels 14, 16 via a transmission through an agricultural field 20. Alternatively, the harvester 10 may be a track-driven harvester and, thus, may include tracks driven by the source of power as opposed to the illustrated wheels 14, 16. The source of power may also drive a hydraulic fluid pump configured to generate pressurized hydraulic fluid for powering various hydraulic components of the harvester 10.

The harvester 10 may also include a material processing system 22 incorporating various components, assemblies, and/or sub-assemblies of the harvester 10 for cutting, processing, cleaning, and discharging sugarcane as the cane is harvested from the agricultural field 20. For instance, the material processing system 22 may include a topper assembly 24 positioned at the front end portion of the harvester 10 to intercept sugarcane as the harvester 10 is moved in the forward direction. As shown, the topper assembly 24 may include both a gathering disk 26 and a cutting disk 28. The gathering disk 26 may be configured to gather the sugarcane stalks so that the cutting disk 28 may be used to cut off the top of each stalk. In some cases, the height of the topper assembly 24 may be adjustable via a pair of arms 30 hydraulically raised and lowered, as desired, by the operator.

The material processing system 22 may further include a crop divider 32 that extends upwardly and rearwardly from the field 20. In general, the crop divider 32 may include two spiral feed rollers 34. Each feed roller 34 may include a ground shoe 36 at its lower end portion to assist the crop divider 32 in gathering the sugarcane stalks for harvesting. Moreover, as shown in FIG. 1, the material processing system 22 may include a knock-down roller 38 positioned near the front wheels 14 and a fin roller 40 positioned behind the knock-down roller 38. As the knock-down roller 38 is rotated, the sugarcane stalks being harvested are knocked down while the crop divider 32 gathers the stalks from agricultural field 20. Further, as shown in FIG. 1, the fin roller 40 may include a plurality of intermittently mounted fins 42 that assist in forcing the sugarcane stalks downwardly. As the fin roller 40 is rotated during the harvest, the sugarcane stalks that have been knocked down by the knock-down roller 38 are separated and further knocked down by the fin roller 40 as the harvester 10 continues to be moved in the forward direction relative to the field 20.

Referring still to FIG. 1, the material processing system 22 of the harvester 10 may also include a base cutter assembly 44 positioned behind the fin roller 40. In various examples, the base cutter assembly 44 may include blades for severing the sugarcane stalks as the cane is being harvested. The blades, located on the peripheral portion of the base cutter assembly 44, may be rotated by a hydraulic motor powered by the vehicle's hydraulic system. Additionally, in several embodiments, the blades may be angled downwardly to sever the base of the sugarcane as the cane is knocked down by the fin roller 40.

Moreover, the material processing system 22 may include a feed roller assembly 46 located downstream of the base cutter assembly 44 for moving the severed stalks of sugarcane from base cutter assembly 44 along the processing path of the material processing system 22. As shown in FIG. 1, the feed roller assembly 46 may include a plurality of bottom rollers 48 and a plurality of opposed, top rollers 50. The various bottom and top rollers 48, 50 may be used to pinch the harvested sugarcane during transport. As the sugarcane is transported through the feed roller assembly 46, debris (e.g., rocks, dirt, and/or the like) may be allowed to fall through bottom rollers 48 onto the field 20.

The material processing system 22 may further include a chopper assembly 52 located at the downstream end portion of the feed roller assembly 46 (e.g., adjacent to the rearward-most bottom and top rollers 48, 50). In general, the chopper assembly 52 may be used to cut or chop the severed sugarcane stalks into pieces or “billets” 54, which may be, for example, six (6) inches long. The billets 54 may then be propelled towards an elevator assembly 56 of the material processing system 22 for delivery to an external receiver or storage device.

The pieces of debris 58 (e.g., dust, dirt, leaves, etc.) separated from the sugar billets 54 may be expelled from the harvester 10 through a primary extractor 60 of the material processing system 22, which is located downstream of the chopper assembly 52 and is oriented to direct the debris 58 outwardly from the harvester 10. Additionally, an extractor fan 62 may be mounted within a housing 64 of the primary extractor 60 for generating a suction force or vacuum to force the debris 58 through the primary extractor 60. The separated or cleaned billets 54, heavier than the debris 58 being expelled through the extractor 60, may then be directed to the elevator assembly 56.

As shown in FIG. 1, the elevator assembly 56 may include an elevator housing 66 and an elevator 68 extending within the elevator housing 66 between a lower, proximal end portion 70 and an upper, distal end portion 72. In general, the elevator 68 may include a looped chain 74 and a plurality of flights or paddles 76 attached to and evenly spaced on the chain 74. The paddles 76 may be configured to hold the sugar billets 54 on the elevator 68 as the billets 54 are elevated along a top span of the elevator 68 defined between its proximal and distal end portions 70, 72. A region 78 for retaining the harvested material may be defined between first and second paddles 76 operably coupled with the elevator 68. As such, a first region may be defined between first and second paddles 76, a second region may be defined between the second and a third paddle 76, and so on. Additionally, the elevator 68 may include lower and upper sprockets 80, 82 positioned at its proximal and distal end portions 70, 72, respectively. As shown in FIG. 1, an elevator motor 84 may be coupled to one of the sprockets (e.g., the upper sprocket 82) for driving the chain 74, thereby allowing the chain 74 and the paddles 76 to travel in a loop between the proximal and distal end portions 70, 72 of the elevator 68.

Moreover, in some embodiments, the pieces of debris 58 (e.g., dust, dirt, leaves, etc.) separated from the elevated sugar billets 54 may be expelled from the harvester 10 through a secondary extractor 86 of the material processing system 22 coupled to the rear end portion of the elevator housing 66. For example, the debris 58 expelled by the secondary extractor 86 remaining after the billets 54 are cleaned and debris 58 expelled by the primary extractor 60. As shown in FIG. 1, the secondary extractor 86 may be located adjacent to the distal end portion 72 of the elevator 68 and may be oriented to direct the debris 58 outwardly from the harvester 10. Additionally, an extractor fan 88 may be mounted at the base of the secondary extractor 86 for generating a suction force or vacuum sufficient to force the debris 58 through the secondary extractor 86. The separated, cleaned billets 54, heavier than the debris 58 expelled through the extractor 86, may then fall from the distal end portion 72 of the elevator 68. In some examples, the billets 54 may be directed into an elevator discharge opening 90 of the elevator assembly 56 into an external storage device, such as a sugar billet cart.

During operation, the harvester 10 is traversed across the agricultural field 20 for harvesting sugarcane. After the height of the topper assembly 24 is adjusted via the arms 30, the gathering disk 26 on the topper assembly 24 may function to gather the sugarcane stalks as the harvester 10 proceeds across the field 20, while the cutter disk 28 severs the leafy tops of the sugarcane stalks for disposal along either side of harvester 10. As the stalks enter the crop divider 32, the ground shoes 36 may set the operating width to determine the quantity of sugarcane entering the throat of the harvester 10. The spiral feed rollers 34 then gather the stalks into the throat to allow the knock-down roller 38 to bend the stalks downwardly in conjunction with the action of the fin roller 40. Once the stalks are angled downward as shown in FIG. 1, the base cutter assembly 44 may then sever the base of the stalks from field 20. The severed stalks are then, by the movement of the harvester 10, directed to the feed roller assembly 46.

The severed sugarcane stalks are conveyed rearwardly by the bottom and top rollers 48, 50, which compress the stalks, make them more uniform, and shake loose debris 58 to pass through the bottom rollers 48 to the field 20. At the downstream end portion of the feed roller assembly 46, the chopper assembly 52 cuts or chops the compressed sugarcane stalks into pieces or billets 54 (e.g., six-inch cane sections). The processed crop material discharged from the chopper assembly 52 is then directed as a stream of billets 54 and debris 58 into the primary extractor 60. The airborne debris 58 (e.g., dust, dirt, leaves, etc.) separated from the sugar billets is then extracted through the primary extractor 60 using suction created by the extractor fan 62. The separated/cleaned billets 54 then directed into an elevator hopper 92 into the elevator assembly 56 and travel upwardly via the elevator 68 from its proximal end portion 70 to its distal end portion 72. During normal operation, once the billets 54 reach the distal end portion 72 of the elevator 68, the billets 54 fall through the elevator discharge opening 90 to an external storage device. If provided, the secondary extractor 86 (with the aid of the extractor fan 88) blows out trash/debris 58 from harvester 10, similar to the primary extractor 60.

In various examples, the harvester 10 may also include one or more sensor assemblies 94, 96 each including various onboard sensor(s) for monitoring one or more operating parameters or conditions of the harvester 10. For example, the sensor system may include a first sensor assembly 94, which may be located in a first portion of the material processing system 22, providing a first indication of the volume of harvested materials, and a second sensor assembly 96, which may be located in a second portion of the material processing system 22, providing a second indication of the volume of harvested materials. In some examples, the first sensor assembly 94 may be positioned downstream of the second sensor assembly 96. Based on a comparison of the first indication of the volume of harvested materials to the second indication of the volume of harvested materials, one or more control actions for the harvester 10 may be generated.

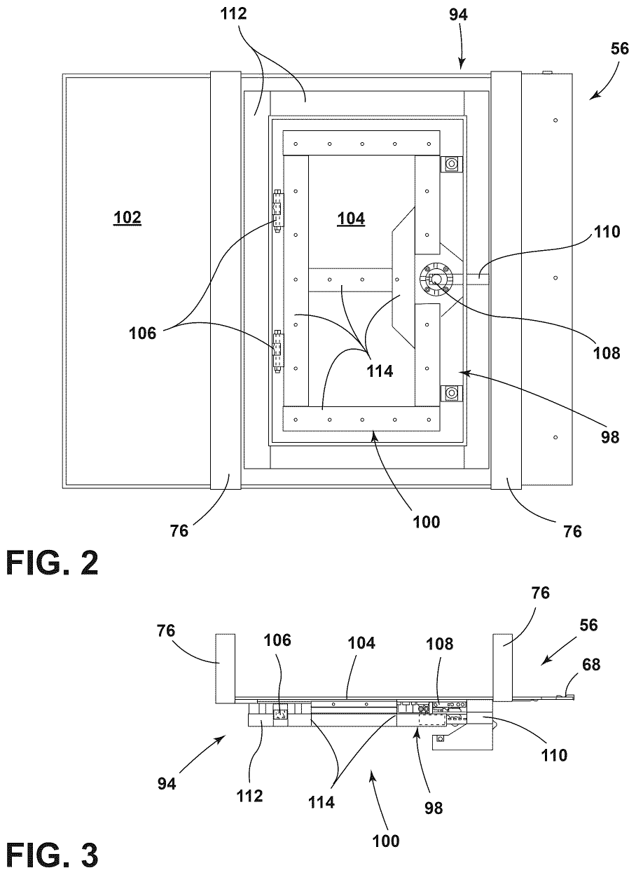

Referring now to FIGS. 2 and 3, a first sensor assembly 94 is illustrated in accordance with aspects of the present disclosure. In the illustrated examples, the first sensor assembly 94 is configured to be positioned within the elevator assembly 56 (FIG. 1) and downstream of the chopper assembly 52 (FIG. 1) and/or the primary extractor 60 (FIG. 1). However, it will be appreciated that the first sensor assembly 94 may be located anywhere within the harvester 10 without departing from the teachings of the present disclosure.

As illustrated in FIGS. 2 and 3, in various examples, the first sensor assembly 94 can include one or more mass sensors 98 configured to capture data indicative of a mass of the harvested materials within the region 78 defined between two adjacent paddles 76, an area defined by the boundary of the mass sensor 98, and/or any other defined space. In various examples, the one or more mass sensors 98 may be configured as a weigh pad 100 disposed in a generally co-planar relation with a section 102 of the elevator 68. The weigh pad 100 can incorporate a plate member 104 pivotally mounted with respect to the elevator 68 by one or more hinges 106. The weigh pad 100 may further include a transducer 108, which may be in the form of at least one load cell, arranged to support a portion of the plate member 104. The load cell(s) is suitably mounted between the plate member 104 and a support member 110. Additionally or alternatively, the one or more mass sensors 98 may be configured as one or more vision-based sensors may be configured as an area-type image sensor, such as a CCD or a CMOS image sensor, and image-capturing optics that capture an image of an imaging field. In various embodiments, the image sensor may correspond to a stereographic camera having two or more lenses with a separate image sensor for each lens to allow the camera to capture stereographic or three-dimensional images. Additionally or alternatively, the one or more mass sensors 98 may be configured as any other practicable device.

As illustrated in FIGS. 2 and 3, the weigh pad 100 may be disposed in an aperture defined by the elevator 68. A sub-frame 112 can be located about a peripheral portion of the aperture to provide structural integrity and mounting points for the one or more hinges 106. The one or more hinges 106 can also be mounted on an inner supporting frame 114 for the plate member 104, such that the pad pivots adjacent to its front end portion. In various examples, the weigh pad 100 can be supported at its rear end portion by the load cell carried, which may be operably coupled to a supporting bracket member 35. It will be appreciated, however, that the position of any component of the first sensor assembly 94 may be adjusted without departing from the teachings of the present disclosure.

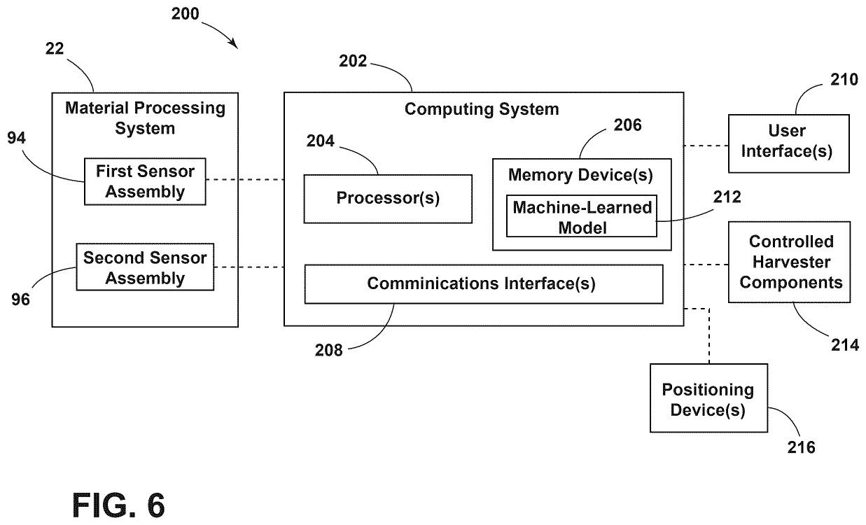

As provided herein, each region 78 of the elevator 68 may be configured to retain billets 54 that traverse across the weigh pad 100 as the billets 54 are translated through the elevator assembly 56. Thus, the billets 54 may be weighed during their traverse of the weigh pad 100 such that mass data may be captured by the transducer 108 in response to deflection of the weigh pad 100. As will be described below, a computing system 202 (FIG. 6) may be provided in association with the first sensor assembly 94 that is configured to determine or estimate a first mass flow rate of the harvested materials through the harvester's material processing system 22 based on sensor feedback associated with the first sensor assembly 94. For instance, in several embodiments, the computing system 202 may be communicatively coupled to the above-described mass sensors 98 to obtain data associated with the mass of the harvested materials being directed through the material processing system 22, thereby allowing the first mass flow rate of the harvested materials to be subsequently calculated or determined. For instance, the first mass flow rate through the material processing system 22 (e.g., an instantaneous mass flow rate through the system) can be determined by using the following relationship (Equation 1):

$$F ( t ) = M * V \qquad ( 1 )$$

where F(t) is mass flow rate (kg/s), M is mass of material per unit length (kg/m), and V is linear speed of mass of material (m/s).

In some instances, such as the example illustrated in FIGS. 2 and 3, the pivoting action of the weigh pad 100 causes the load cell to measure half the mass passing over the plate. Thus the actual calculation of mass flow rate, in some cases, can be determined by using the following relationship (Equation 2):

$${F}_{1} ( t ) = \frac{( 2 * {M}_{s v} * {V}_{e l e v} )}{{L}_{p a d}} , \qquad ( 2 )$$

where F₁(t) is a first mass flow rate (kg/s), Mₛᵥ is average mass on load cell (kg), Vₑₗₑᵥ is the speed of the elevator (m/s), and L_{pad} is the length of the plate member (m).

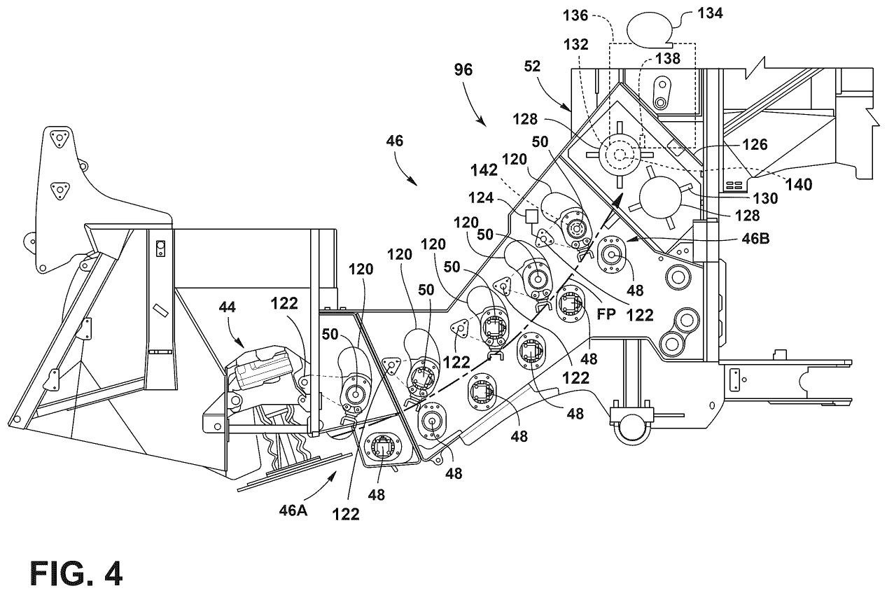

Referring now to FIG. 4, a side view of a portion of a material processing system 22 of an agricultural harvester 10 is illustrated in accordance with aspects of the present subject matter. As shown in FIG. 4, the feed roller assembly 46 extends between a first end portion 46A and a second end portion 46B, with the first end portion 46A of the feed roller assembly 46 being adjacent to the base cutter assembly 44 and the second end portion 46B of the feed roller assembly 46 being adjacent the chopper assembly 52. As such, the first end portion 46A of the feed roller assembly 46 is configured to receive harvested materials (e.g., severed sugarcane stalks) from the base cutter assembly 44 and to convey the flow of harvested materials along a flow path FP defined between the bottom and top rollers 48, 50 to the chopper assembly 52 at the second end portion 46B of the feed roller assembly 46. While the feed roller assembly 46 is shown as having six bottom rollers 48 and five top rollers 50, it will be appreciated that the feed roller assembly 46 may have any other suitable number of bottom and/or top rollers 48, 50.

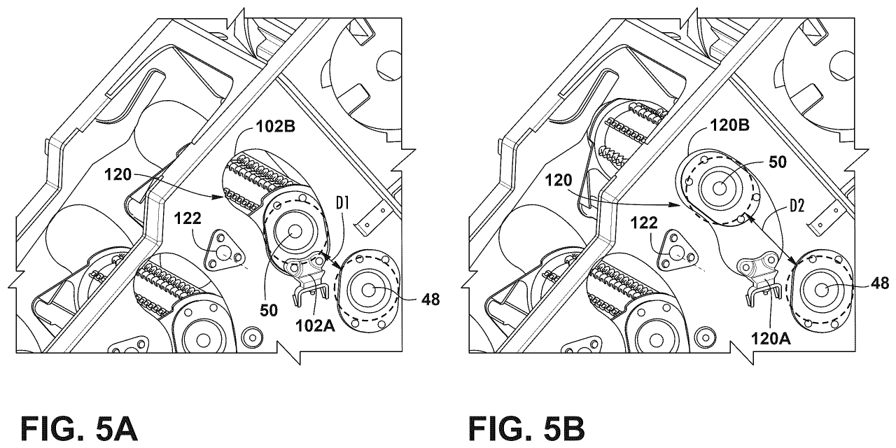

Due to variations in the volume of harvested materials being processed by the material processing system 22, the flow of harvested materials through the feed roller assembly 46 will inherently vary in thickness. As such, one set of the rollers of the feed roller assembly 46 may be configured as floating rollers (with the other set of rollers being configured as fixed or non-floating rollers) such that the spacing between the bottom and top rollers 48, 50 can be varied to account for changes in the volume of the harvested materials being directed through the feed roller assembly 46. For instance, each of the top rollers 50 can be movable within a respective slot 120. As shown in FIGS. 5A and 5B, each slot 120 may extend between a first slot end portion 120A and a second slot end portion 120B. When the top roller 50 abuts against the first slot end portion 120A, the top roller 50 is in a lowest position, such that the top roller 50 is spaced by a first distance D1 from the respective bottom roller 48. When the top roller 50 abuts against the second slot end portion 120B, the top roller 50 is in a highest position, such that the top roller 50 is spaced by a second distance D2 from the respective bottom roller 48. In various examples, the first distance D1 is the closest that the top roller 50 may be from the adjacent bottom roller 48 and the second distance D2 is the furthest that the top roller 50 may be from the adjacent bottom roller 48. In some examples, the top rollers 50 are pivotable about a respective pivot joint 122 to move within the slot 120 between the first and second slot end portions 120A, 120B. For instance, the top roller 50 may be pivoted about the pivot joint 122 between a first angular position, corresponding to the first distance D1, and a second angular position, corresponding to the second distance D2. However, in other instances, the top rollers 50 may be configured to move within the slot 120 in any other suitable way. Alternatively, the top rollers 50 may be fixed or non-floating, and the bottom rollers 48 may, instead, be movable to allow the spacing between the bottom and top rollers 48, 50 to be varied.

In various examples, the second sensor assembly 96 may be provided in association with the feed roller assembly 46 for detecting variations in the spacing between the bottom and top rollers 48, 50, thereby providing an indication of the volume of harvested materials being directed through the feed roller assembly 46. For example, the second sensor assembly 96 can include one or more displacement sensors 124 that may be provided for detecting the displacement of one or more respective top rollers 50 of the feed roller assembly 46, including the magnitude and/or rate of the displacement. For instance, as shown in FIG. 4, a displacement sensor 124 is provided in operative association with the furthest downstream top roller 50 of the feed roller assembly 46 to detect the displacement of the roller 50 relative to the adjacent bottom roller 48 as harvested materials are directed through the feed roller assembly 46, thereby providing an indication of the material volume being processed through the material processing system 22. Additionally or alternatively, the bottom rollers 48 can be movable, and the top rollers 50 can be fixed or non-floating such that the displacement sensor(s) 124 may, instead, be configured to detect the displacement of one or more of the bottom rollers 48 as harvested materials are directed through the feed roller assembly 46.

It will be appreciated that, although a single displacement sensor 124 is shown as being associated with the feed roller assembly 46, any number of displacement sensors 124 may be used to monitor the displacement of any number of the floating rollers so as to provide an indication of the volume of harvested materials being directed through the feed roller assembly 46. It will further be appreciated that the displacement sensor(s) 124 may be configured as any suitable sensor(s) or combination of sensors for detecting displacement of an associated floating roller of the feed roller assembly 46, such as angular position sensors, accelerometers, and/or the like. Additionally, it will be appreciated that any other suitable type of sensor(s) may be used to capture data indicative of the volume of harvested materials being directed through the material processing system 22 of the harvester 10, such as cameras and/or other imaging devices, radar or sonar sensors, and/or the like.

Additionally, as shown in FIG. 4, the chopper assembly 52 may generally include an outer housing 126 and one or more chopper drums 128 rotatably supported within the chopper housing 126. The chopper drums 128 can be configured to be rotatably driven within the housing 126 such that chopper elements 130 extending outwardly from each drum 128 (e.g., blades) cut or chop the harvested materials received from the feed roller assembly 46, thereby generating a stream of processed harvested materials (e.g., including both billets 54 and debris 58) that is discharged from the chopper assembly 52 via an outlet of the housing 126. Additionally, as shown in FIG. 4, a hydraulic motor(s) 132 is provided in association with the chopper drums 128 for rotationally driving the drums 128. The hydraulic motor(s) 132 is, in turn, fluidly coupled to a hydraulic pump 134 of the vehicle's hydraulic system (e.g., via an associated hydraulic circuit 136) such that pressurized hydraulic fluid can be delivered from the pump 134 to rotationally drive the motor(s) 132.

During the operation of the chopper assembly 52, an anti-rotation or resistive force is applied to the chopper drums 128 that generally varies depending on both the volume of harvested materials being directed between the chopper drums 128 and the density of such harvested materials. As indicated above, the volume of harvested materials can be monitored or determined by detecting the floating roller displacement within the feed roller assembly 46. Thus, by knowing the volume of harvested materials, the material density of the harvested materials can be estimated or inferred by detecting one or more parameters indicative of the resistive force applied to the chopper drums 128 by the harvested materials being directed therebetween. In several embodiments, this resistive force (and, thus, the density of the harvested materials) can be related to the pressure of the hydraulic fluid that is supplied to the hydraulic motor(s) 132 in order to maintain the drums 128 rotating at a given rotational speed (e.g., a desired RPM setting). Thus, the second sensor assembly 96 can include one or more pressure sensors 138 that may be provided to monitor the fluid pressure associated with the hydraulic motor(s) 132, thereby providing an indication of the density of the harvested materials being directed through the chopper assembly 52. For instance, as shown in FIG. 4, a pressure sensor 138 is provided in fluid communication with the hydraulic circuit 136 coupling the motor 132 to the pump 134 to monitor the fluid pressure of the hydraulic fluid being suppled thereto.

It will be appreciated that, although a single pressure sensor 138 is shown as being used to monitor the fluid pressure associated with the operation of the chopper assembly 52, any number of pressure sensors 138 may be used to monitor the fluid pressure. Additionally, it will be appreciated that any other suitable type of sensor(s) may be used to capture data indicative of the density of the materials being directed through the material processing system 22, such as any other suitable sensor(s) configured to detect a parameter associated with the resistive force applied to the chopper drums 128 of the chopper assembly 52.

It should also be appreciated that various other sensors or sensing devices may be provided in operative association with the feed roller assembly 46, the chopper assembly 52, and or any other component of the material processing assembly. For example, one or more speed sensors may be provided to monitor the rotational speed of the feeder rollers 48, 50, and/or the chopper drums 128. For instance, as shown in FIG. 4, a first speed sensor 140 may be provided in association with the chopper assembly 52 to monitor the rotational speed of the chopper drums 128, such as by installing the sensor 142 in association with the motor 132 driving the drums 128. Additionally, as shown in FIG. 4, a second speed sensor 142 may be provided in association with the feed roller assembly 46 to monitor the rotational speed of the rollers and, thus, the feed rate through the assembly 46.

As will be described below, a computing system 202 may be provided in association with an agricultural harvester 10 that is configured to determine or estimate a second mass flow rate of the harvested materials through the harvester's material processing system 22 based on sensor feedback associated with the second sensor assembly 96. For instance, in several embodiments, the computing system 202 may be communicatively coupled to the above-described sensor assemblies 94, 96 to obtain data associated with the volume and density of the harvested materials being directed through the material processing system 22, thereby allowing the second mass flow rate of the harvested materials to be subsequently calculated or determined. For instance, the volume-related data received from the displacement sensor(s) 124 may be used to determine a volumetric flow rate of the harvested materials through the feeder assembly 46, while the density-related data received from the pressure sensor(s) 138 may be used to determine the material density of the harvested materials. Such variables may be then used to calculate the second mass flow rate through the material processing system 22 (e.g., an instantaneous mass flow rate through the system) using the following relationship (Equation 3):

$${F}_{2} ( t ) = Q * φ , \qquad ( 3 )$$

wherein F₂(t) corresponds to the mass flow rate of the harvested materials in kilograms per second (kg/s); Q corresponds to the volumetric flow rate of the harvested materials in meters cubed per second (m³/s); and φ corresponds to the density of the harvested materials in kilograms per meters cubed (kg/m³).

As indicated above, the volume-related roller displacement data provided via the displacement sensors 124 may be used to determine the volumetric flow rate of the harvested materials through the material processing system 22. For instance, the displacement data may allow for the distance or height defined between the bottom and top rollers 48, 50 to be determined, which may then be used to calculate the volumetric flow rate. For instance, in one implementation, the volumetric flow rate may be calculated using the following equation (Equation 4):

$$Q = \frac{W * H * V}{60} , \qquad ( 4 )$$

wherein Q corresponds to the volumetric flow rate of the harvested materials in meters cubed per second (m³/s): W corresponds to the width of the feeder assembly 46 in meters (m) (e.g., at the location within the feed roller assembly 46 at which the floating roller displacement is being monitored); H corresponds to the distance or height defined between the bottom and top rollers 48, 50 in meters (m) (e.g., at the location within the feed roller assembly 46 at which the floating roller displacement is being monitored); and V corresponds to the speed at which the harvested materials are being fed through the feeder assembly 46 in meters per minute (m/min) (e.g., as determined as a function of the rotational speed of the rollers 48, 50 of the feeder assembly 46 or as a function of the rotational speed of the chopper drums 128 when a known relationship exists between the chopper drum rotation and the roller rotation, one or both of which can be monitored via the speed sensors 142, 144 described above).

It will be appreciated that, although Equation 4 above incorporates a denominator value of 60 for converting minutes-to-seconds (e.g., to allow the determined second mass flow rate to be expressed in kilograms per second (kg/s)), any other suitable time basis or units may be used for the equations contained herein.

The distance or height (H) defined between the bottom and top rollers 48, 50 may also be expressed as a function of the percentage that the monitored roller has been currently displaced between its minimum height (e.g., when the top roller 50 is at position 120A in slot 120 and distance D1 is defined between the bottom and top rollers 48, 50) and its maximum height (e.g., when the top roller 50 is at position 120B in slot 120 and distance D2 is defined between the bottom and top rollers 48, 50), such as by using the expression (Equation 5):

$$H = D 1 + ( D 2 - D 1 ) * D P \qquad ( 5 )$$

wherein: H corresponds to the distance or height currently defined between the bottom and top rollers 48, 50 in meters (m); D1 corresponds to the minimum height that can be defined between the bottom and top rollers 48, 50 in meters (m); D2 corresponds to the maximum height that can be defined between the bottom and top rollers 48, 50 in meters (m); and DP corresponds to the displacement percentage of the monitored roller between its minimum and maximum positions 120A, 120B as monitored via the displacement sensor(s) 124.

Moreover, as indicated above, the density-related data provided via the pressure sensors 138 may be used to determine the density of the harvested materials directed through the material processing system 22. Specifically, in several embodiments, the instantaneous chopper-related pressure that is detected while chopping harvested materials can be compared to a baseline chopper-related pressure associated with the chopper drums 128 being rotated without any resistive force applied thereto (e.g., when the chopper drums 128 are being rotated without any materials being directed therebetween) to determine a pressure differential between such pressures. This pressure differential may then be used in combination with a correction factor that takes into account the volume of harvested materials being directed through the chopper assembly 52 to determine the material density. For instance, the density of the harvested materials may be calculated using the following equation (Equation 6):

$$φ = X * ( {P}_{w o r k} - {P}_{e m p t y} ) , \qquad ( 6 )$$

wherein φ corresponds to the density of the harvested materials in kilograms per meters cubed (kg/m³); X corresponds to a correction or adjustment factor in kilograms per meters cubed bar (kg/m³ bar) determined as a function of the volume of harvested materials being directed through the chopper assembly 52 (e.g., by using an associated look-up table that correlates the volume determine via the displacement sensor(s) 124 to the adjustment factor); P_{work} corresponds to the instantaneous or monitored fluid pressure associated with the chopper assembly 52 in bars as harvested materials are being processed by the assembly 50 (e.g., as determined based on the data received from the pressure sensor(s)); and P_{empty} corresponds to the baseline fluid pressure associated with the chopper assembly 52 operating without any harvested materials being processed by the assembly 50.

It will be appreciated that the above-referenced equations may be combined to allow for the second mass flow rate of the harvested materials to be expressed as a function of both the displacement percentage (e.g., as determined as a function of the data received from the displacement sensor(s) 124) and the fluid pressure (e.g., as determined as a function of the data received from the pressure sensor(s) 138). For instance, the second mass flow rate may be expressed according to the following relationship (Equation 7):

$${F}_{2} ( t ) = \frac{W * ( D 1 + ( D 2 - D 1 ) * D P ) * V}{60} * X * ( {P}_{w o r k} - {P}_{e m p t y} ) , \qquad ( 7 )$$

wherein F₂(t) corresponds to the mass flow rate of the harvested materials in kilograms per second (kg/s); W corresponds to the width of the feeder assembly 46 in meters (m); D1 corresponds to the minimum height that cab be defined between the bottom and top rollers 48, 50 in meters (m); D2 corresponds to the maximum height that can be defined between the bottom and top rollers 48, 50 in meters (m); DP corresponds to the displacement percentage of the monitored roller between its minimum and maximum positions 120A, 120B; V corresponds to the speed at which the harvested materials are being fed through the feeder assembly 46 in meters per minute (m/min); X corresponds to a correction or adjustment factor in kilograms per meters cubed bar (kg/m³ bar) determined as a function of the volume of harvested materials being directed through the chopper assembly 52; P_{work} corresponds to the instantaneous or monitored fluid pressure associated with the chopper assembly 52 in bars as harvested materials are being processed by the assembly 50; and P_{empty} corresponds to the baseline fluid pressure associated with the chopper assembly 52 operating without any harvested materials being processed by the assembly 50.

Referring now to FIG. 6, a schematic view of a system 200 for monitoring the crop yield of an agricultural harvester 10 is illustrated in accordance with aspects of the present subject matter. In general, the system 200 will be described herein with reference to the agricultural harvester 10 and associated components described above with reference to FIGS. 1-5B. However, it will be appreciated that the disclosed system 200 may be implemented with harvesters having any other suitable configurations.

As shown in FIG. 6, the system 200 may include a computing system 202 and various other components 214 configured to be communicatively coupled to and/or controlled by the computing system 202. For instance, the computing system 202 may be communicatively coupled to the first sensor assembly 94 that captures data associated with a first mass flow rate of the harvested materials directed through the material processing system 22 of the harvester 10. Additionally or alternatively, the computing system 202 may also be communicatively coupled to the second sensor assembly 96 that captures data associated with a second mass flow rate of the harvested materials directed through the material processing system 22 of the harvester 10.

The computing system 202 may be configured to initiate or execute one or more control actions associated with the monitored crop yield. For example, the control actions may include generating a notification when an error between the first mass flow rate and the second mass flow rate exceeds a defined threshold, possibly for a predefined amount of time. In addition, the computing system 202 may be communicatively coupled to and/or configured to control a user interface 210. The user interface 210 described herein may include, without limitation, any combination of input and/or output devices that allow an operator to provide inputs to the computing system 202 and/or that allow the computing system 202 to provide feedback to the operator, such as a keyboard, display, keypad, pointing device, buttons, knobs, touch sensitive screen, mobile device, audio input device, audio output device, and/or the like.

Additionally or alternatively, the one or more control actions may include recalibrating the calculated mass flow rate of the first sensor assembly 94 based on the data from the second sensor assembly 96 and/or recalibrating the calculated mass flow rate of the second sensor assembly 96 based on the data from the first sensor assembly 94. Additionally or alternatively, the one or more control actions may include controlling or automating one or more harvester components 214 based at least in part on the first mass flow rate and/or the second mass flow rate. In such instances, the computing system 202 may be communicatively coupled to and/or configured to control one or more additional components 214 of the harvester 10 to allow the computing system 202 to, for example, automate the operation of such harvester components 214.

In general, the computing system 202 may be configured as any suitable processor-based device, such as a computing device or any suitable combination of computing devices. Thus, in several embodiments, the computing system 202 may include one or more processor(s) 204, and the associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application-specific integrated circuit, and other programmable circuits. Additionally, the memory device(s) 206 of the computing system 202 may generally comprise memory element(s) including, but not limited to, a computer-readable medium (e.g., random access memory RAM)), a computer-readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 206 may generally be configured to store suitable computer-readable instructions that, when implemented by the processor(s) 204, configure the computing system 202 to perform various computer-implemented functions, such as one or more aspects of the methods and algorithms that will be described herein.

It will be appreciated that, in several embodiments, the computing system 202 may correspond to an existing controller of the agricultural harvester 10. However, it will be appreciated that the computing system 202 may instead correspond to a separate processing device. For instance, in some examples, the computing system 202 may form all or part of a separate plug-in module that may be installed within the agricultural harvester 10 to allow for the disclosed system and method to be implemented without requiring additional software to be uploaded onto existing control devices of the agricultural harvester 10.

In some embodiments, the computing system 202 may be configured to include one or more communications modules or interfaces 208 for the computing system 202 to communicate with any of the various system components described herein. For instance, one or more communicative links or interfaces (e.g., one or more data buses) may be provided between the computing system 202 and the first sensor assembly 94 to receive sensor data associated with a mass of the harvested materials being directed through the material processing system 22 and/or the second sensor assembly 96 to receive sensor data associated with the volume and density of the harvested materials being directed through the material processing system 22. Further, one or more communicative links or interfaces (e.g., one or more data buses) may be provided between the communications interface 208 and the user interface 210 to allow operator inputs to be received by the computing system 202 and/or the allow the computing system 202 to control the operation of one or more components of the user interface 210. Moreover, one or more communicative links or interfaces (e.g., one or more data buses) may be provided between the communications interface 208 and any other suitable harvester component(s) 214 to allow the computing system 202 to control the operation of such component(s) 214.

As indicated above, the computing system 202 may be configured to monitor the crop yield by estimating or determining a first mass flow rate of the harvested materials through the material processing system 22 of the harvester 10 based on data received from the first sensor assembly 94. For example, the computing system 202 may include one or more suitable relationships and/or algorithms stored within its memory 206 that, when executed by the processor 204, allow the computing system 202 to estimate or determine the first mass flow rate of the harvested materials through the material processing system 22 based at least in part on the sensor data provided by the transducer 108. Such relationships and/or algorithms may include or incorporate, for instance, one or more of the mathematical expressions described above with reference to Equations 1 and 2. For instance, the computing system 202 may be configured to monitor the mass data received from the transducer 108 to determine the instantaneous mass of the harvested materials.

In addition, as indicated above, the computing system 202 may be configured to monitor the crop yield by estimating or determining a second mass flow rate of the harvested materials through the material processing system 22 of the harvester 10 based on data received from the second sensor assembly 96. For example, the computing system 202 may include one or more suitable relationships and/or algorithms stored within its memory 206 that, when executed by the processor 204, allow the computing system 202 to estimate or determine the second mass flow rate of the harvested materials through the material processing system 22 based at least in part on the sensor data provided by the volume-related and density-related sensors. Such relationships and/or algorithms may include or incorporate, for instance, one or more of the mathematical expressions described above with reference to Equations 3-7. For instance, the computing system 202 may be configured to monitor the displacement data received from the displacement sensor(s) 124 to determine the instantaneous displacement percentage of the monitored floating roller (which is indicative of the current distance or height defined between such floating roller and the adjacent fixed roller) and the pressure data received from the pressure sensor(s) 138 to determine the instantaneous fluid pressure associated with the current operation of the chopper assembly 52. Such continuously monitored parameters may then be used to calculate the instantaneous mass flow rate of the harvested materials being directed through the material processing system 22 of the harvester 10, such as by inputting such monitored parameters into the afore-mentioned Equation 5 and/or by using one or more related look-up tables to “look-up” the mass flow rate associated with such monitored parameters.

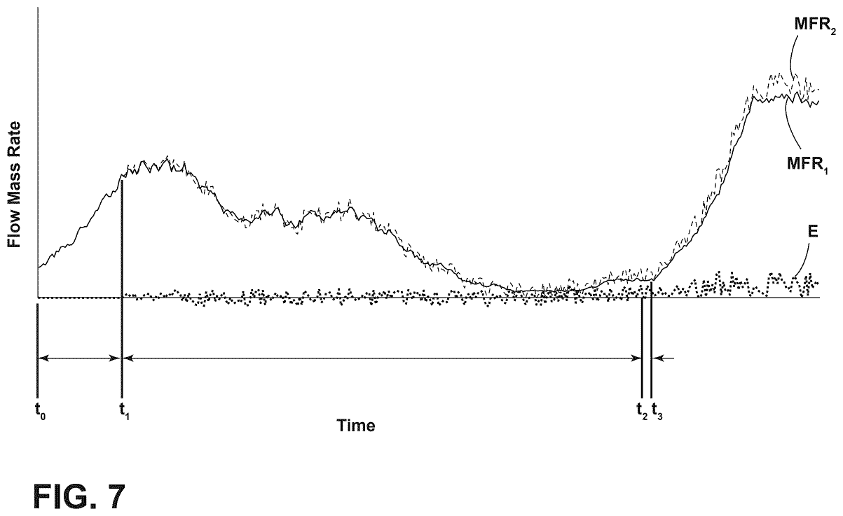

Further, the computing system 202 may be configured to determine an error between the first mass flow rate and the second mass flow rate. The error may be defined as the difference between the first mass flow rate and the second mass flow rate, and/or any other comparable parameters that may be generated based on data from the first sensor assembly 94 and the second sensor assembly 96. In some instances, the error may be quantified as an absolute value of the difference between the first mass flow rate and the second mass flow rate. For example, as illustrated in FIG. 7, the first mass flow rate MFR₁ may be varied from the second mass flow rate MFR₂ over time. In addition, the error E may be generated over time as well. In various examples, the data captured by the first sensor assembly 94 and/or the data captured by the second sensor assembly 96 may allow for intermittent or continuous calculations of the first and second mass flow rates MFR₁, MFR₂. In addition, a sample rate of the one or more sensors of the first sensor assembly 94 may be varied from one another and/or from the one or more sensors of the second assembly. In such instances, a mass flow rate between subsequent samples may be interpolated or otherwise calculated such that the error E may be calculated.

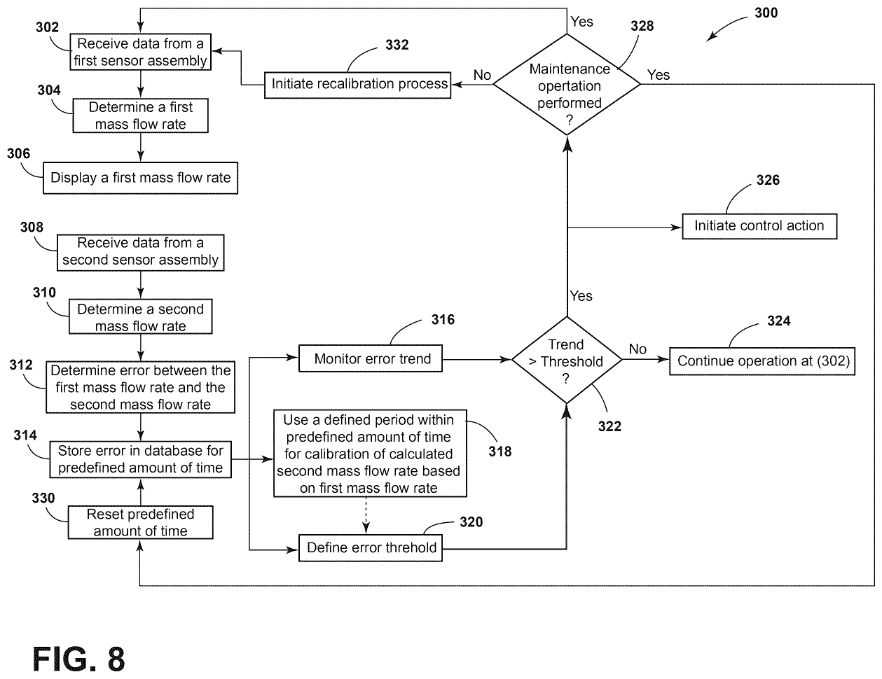

With further reference to FIGS. 7 and 8, in some instances, the accuracy of the first assembly may have a first level of accuracy after maintenance operation, in the form of a cleaning operation, is performed and a second accuracy after a portion of a harvesting application has been completed. The second accuracy may be less than the first accuracy due to contaminants remaining on the elevator 68 and/or the first sensor assembly 94. Conversely, in some instances, the accuracy of the second assembly may have a third level of accuracy after maintenance, in the form of a cleaning operation, is performed and a fourth accuracy after a portion of a harvesting application has been completed. The third accuracy may generally equal to the fourth accuracy. As such, for a defined period after a cleaning operation, which may be the time between t₀ and t₁, the computing system 202 may institute a calibration process. During the calibration process, the first mass flow rate based on the data captured by the first sensor assembly 94 may be used to calibrate the second mass flow rate based on the data captured by the second sensor assembly 96. In such instances, a factor may be generated that is used to update Equation 7 to better correlate the first mass flow rate.

In various examples, the computing system 202 can store or include one or more models, which may be machine-learned models 212, for determining the factor. For example, the machine-learned model 212 may be a machine-learned factor generation model. The machine-learned factor generation model can be configured to receive input data and process the input data to determine the factor. In some examples, the factor generation model can correspond to a linear machine-learned model. For instance, the factor generation model may be or include a linear regression model. A linear regression model may be used to intake the input data from the first sensor assembly 94 and the second sensor assembly 96 and provide an intermittent or continuous output for the factor for calibrating the second sensor assembly 96. Linear regression models may rely on various techniques, such as ordinary least squares, ridge regression, lasso, gradient descent, and/or the like. However, in other embodiments, the factor generation model may be or include any other suitable linear machine-learned model.

Alternatively, the factor generation model may correspond to a non-linear machine-learned model. For instance, the factor generation model may be or include a neural network such as, for example, a convolutional neural network. Example neural networks include feed-forward neural networks, recurrent neural networks (e.g., long short-term memory recurrent neural networks), convolutional neural networks, transformer neural networks (or any other models that perform self-attention), or other forms of neural networks. Neural networks can include multiple connected layers of neurons and networks with one or more hidden layers, which can be referred to as “deep” neural networks. In some instances, at least some of the neurons in a neural network include non-linear activation functions.

As further examples, the factor generation model can be or can otherwise include various other machine-learned models, such as a support vector machine; one or more decision-tree based models (e.g., random forest models); a Bayes classifier; a K-nearest neighbor classifier; and/or other types of models including both linear models and non-linear models.

Once the defined period between t₀ and t₁ is completed, the computing system 202 may institute a monitoring process between t₁ and t₂. During the monitoring process, the error may be monitored relative to the defined threshold. In some examples, when the error between the first mass flow rate and the second mass flow rate exceeds a defined threshold, which is generally indicated at 12, the computing system 202 may also be configured to initiate one or more control actions. In some instances, the control action may be generated when the error exceeds the defined threshold for a predefined amount of time (e.g., 13). For instance, in several embodiments, the computing system 202 may automatically control the operation of the user interface 210 to provide an operator notification associated with the determined mass flow rate. For example, the computing system 202 may control the operation of the user interface 210 in a manner that causes data associated with the determined mass flow rate to be presented to the operator of the harvester 10, such as by presenting raw or processed data associated with the mass flow rate including numerical values, graphs, maps, and/or any other suitable visual indicators.

In some examples, when the error exceeds the defined threshold, the computing system 202 may initiate a recalibration process (e.g., after 12). During the recalibration process, the first mass flow rate may be adjusted by a factor based on the second mass flow rate. In such instances, the factor may be determined based on the magnitude of the error between the first mass flow rate and the second mass flow rate. In some instances, by using the data from the second sensor assembly 96 to recalibrate the first mass flow rate, an amount of time between maintenance operations may be extended. As discussed above, in various examples, the computing system 202 can store or include one or more models, which may be machine-learned models 212, for determining the factor. For example, the machine-learned model 212 may be a machine-learned factor generation model. The machine-learned factor generation model can be configured to receive input data and process the input data to determine the factor.

Additionally, with further reference to FIGS. 7 and 8, the control action initiated by the computing system 202 may be associated with the generation of a yield map based at least in part on the firsts and second mass flow rates. For instance, the computing system 202 may be communicatively coupled to a positioning device(s) 216 installed on or within the harvester 10 that is configured to determine the exact location of the harvester 10, such as by using a satellite navigation position system (e.g. a GPS, a Galileo positioning system, the Global Navigation satellite system (GLONASS), the BeiDou Satellite Navigation and Positioning system, and/or the like). In such an embodiment, the location data provided by the positioning device(s) 216 may be correlated to the mass flow rate calculations to generate a yield map associated with the crop yield at each location within the field 20. For instance, the location coordinates derived from the positioning device(s) 216 and the mass flow rate data may both be time-stamped. In such an embodiment, the time-stamped data may allow each mass flow rate datapoint to be matched or correlated to a corresponding set of location coordinates received from the positioning device(s) 216, thereby allowing the precise location of the portion of the field 20 associated with the mass flow rate datapoint to be determined by the computing system 202. The resulting yield map may, for example, simply correspond to a data table that maps or correlates each mass flow rate datapoint to an associated field location. Alternatively, the yield map may be presented as a geo-spatial mapping of the mass flow rate data, such as a heat map that indicates the variability in the mass flow rate across the field 20.

Moreover, in some embodiments, the computing system 202 may additionally or alternatively be configured to automatically control the operation of one or more components 214 of the harvester 10 based at least in part on the mass flow rate determined as a function of the monitored parameters. For instance, the computing system 202 may be configured to automatically adjust the ground speed of the harvester 10 (e.g., by automatically controlling the operation of the engine, transmission, and/or braking system of the harvester 10), the fan speed associated with one or both extractors 60, 86 (e.g., by automatically controlling the operation of the associated fan 62, 80), the elevator speed e.g., by automatically controlling the operation of the elevator motor 84), a cleaning assembly associated with the first sensor assembly 94, and/or any other suitable operational settings to accommodate variations in the mass flow through the system.

Referring now to FIG. 8, a flow diagram of a method 300 for operating an agricultural harvester is illustrated in accordance with aspects of the present subject matter. In general, the method 300 will be described herein with reference to the agricultural harvester 10 and related components described with reference to FIGS. 1-5B, and the various components of the system 200 described with reference to FIG. 6. However, it will be appreciated that the disclosed method 300 may be implemented with harvesters having any other suitable configurations and/or within systems having any other suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 8, at (302), the method 300 may include receiving data indicative of a first mass flow rate of harvested materials being directed through a material processing system of the harvester. For instance, as described above, the computing system may be communicatively coupled to one or more mass sensors, such as a transducer or imager, which capture data indicative of a mass flow rate as the harvested materials traverse an elevator of the material processing system. As provided herein, the mass sensor may be operably coupled with the material processing system downstream of a chopper assembly of the harvester, a primary extractor of the harvester, and/or any other component of the material harvesting system.

At (304), the method 300 can include determining a first mass flow rate of the flow of harvested materials directed through the material processing system based on the data received from the first sensor assembly. For example, as indicated above, the computing system may be configured to determine the first mass flow rate of the harvested materials being directed through the material processing system based on the data received from the mass sensors. For example, the computing system may include one or more suitable relationships and/or algorithms stored within its memory that, when executed by the processor, allow the computing system to estimate or determine the first mass flow rate of the harvested materials through the material processing system based at least in part on the sensor data provided by the first sensor assembly.

At (306), the method 300 can include displaying information related to the first mass flow rate on a display. For example, as provided herein, the computing system may control the operation of a user interface in a manner that causes data associated with the first mass flow rate to be presented to a user of the harvester, such as by presenting raw or processed data associated with the mass flow rate including numerical values, graphs, maps, and/or any other suitable visual indicators.

At (308), the method 300 may include receiving data from a second sensor assembly. In various examples, the data may be indicative of a volume of a flow of harvested materials being directed through a material processing system of the harvester. For instance, as described above, the computing system may be communicatively coupled to one or more volume-related sensors configured to capture data associated with the volume of the harvested materials being directed through the material processing system. As an example, the volume-related sensor(s) may correspond to one or more displacement sensors configured to detect variations in the distance or height defined between a given pair of adjacent top and bottom rollers of the feed roller assembly by monitoring the displacement of one of such rollers (e.g., the floating roller) relative to the other.

Additionally, the second sensor assembly may also capture data indicative of a density of the flow of harvested materials being directed through the material processing system. For instance, as described above, the computing system may be communicatively coupled to one or more density-related sensors configured to capture data associated with the density of the harvested materials being directed through the material processing system. As an example, the density-related sensor(s) may correspond to one or more pressure sensors configured to detect a fluid pressure associated with the operation of the chopper assembly, such as the fluid pressure of the hydraulic fluid that must be supplied to the hydraulic motor(s) to maintain the chopper drums rotating at a given speed despite the anti-rotation or resistive force applied by the harvested materials against the chopper drums.

Additionally, at (310), the method 300 may include determining a second mass flow rate of the flow of harvested materials directed through the material processing system based on the data received from the second sensor assembly. For example, the computing system may be configured to determine the second mass flow rate of the harvested materials being directed through the material processing system based on the volume-related and density-related data received from the sensors. For example, the computing system may include one or more suitable relationships and/or algorithms stored within its memory that, when executed by the processor, allow the computing system to estimate or determine the second mass flow rate of the harvested materials through the material processing system based at least in part on the sensor data provided by the second sensor assembly.

At (312), the method 300 may include determining an error between the first mass flow rate and the second mass flow rate. The error may be defined as the difference between the first mass flow rate and the second mass flow rate, and/or any other comparable parameters that may be generated based on data from the first sensor assembly and the second sensor assembly.

At (314), the method 300 can include storing the error in a database over a predefined amount of time that is generally equal to the time between maintenance operations, or cleaning operations, of the first sensor assembly and/or the second sensor assembly.

At (316), the method 300 can include monitoring a trend of the error over time over a sample time. As provided herein, in various examples, the data captured by the first sensor assembly and/or the data captured by the second sensor assembly may allow for intermittent or continuous first and second mass flow rates. In addition, a sample rate of the one or more sensors of the first sensor assembly may be varied from one another and/or from the one or more sensors of the second assembly. In such instances, a mass flow rate between subsequent samples may be interpolated or otherwise calculated such that the error may be calculated.

At (318), the method 300 can also include using a defined period within the predefined amount of time for the calibration of the second mass flow rate based on the first mass flow rate. During the calibration process, the first mass flow rate based on the data captured by the first sensor assembly may be used to calibrate the second mass flow rate based on the data captured by the second sensor assembly. In such instances, a factor may be generated that is used to update Equation 7 to better match the first mass flow rate. In various examples, the computing system can store or include one or more models, which may be machine-learned models, for determining the factor.

At (320), the method 300 can include determining an error threshold. In various examples, the error threshold may be inputted through a user interface that may include, without limitation, any combination of input and/or output devices that allow an operator to provide inputs to the computing system and/or that allow the computing system to provide feedback to the operator. Additionally or alternatively, the error threshold may be determined based on the calibration process described in (318).

At (322), the method 300 can include comparing the trend to the threshold. If the trend is not greater than the threshold, at (324), the operation is continued, and the method 300 can return to (302). If the trend is greater than the threshold, at (326), the method 300 can include initiating a control action. For example, as indicated above, the computing system may be configured to initiate any number of control actions in association with the error between the first mass flow rate and the second mass flow rate, including, but not limited to, presenting data associated with the error to the operator via the associated user interface, generating a yield map based at least in part on the error, and/or automatically controlling the operation of a component of the harvester based at least in part on the error.

At (328), the method 300 can include determining whether a maintenance operation has been performed. If the maintenance operation, or cleaning operations of the first sensor assembly and/or the second sensor assembly have occurred, at (330), the method 300 can include resetting the predefined amount of time of (314). In addition, if a maintenance operation or a cleaning operation of the first sensor assembly and/or the second sensor assembly has occurred, the method 300 can return to (302). If a maintenance operation or a cleaning operation of the first sensor assembly and/or the second sensor assembly has not occurred, the method 300, at (332), can include initiating a recalibration process. During the recalibration process, the first mass flow rate may be adjusted by a factor based on the second mass flow rate. In such instances, the factor may be determined based on the magnitude of the error between the first mass flow rate and the second mass flow rate. In some instances, by using the data from the second sensor assembly to recalibrate the first mass flow rate, an amount of time between maintenance operations may be extended.

In various examples, the method 300 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the position of the ground engaging tool and/or any other component of the residue manager assembly. In some instances, the vehicle learning engine may allow for changes to the position of the ground engaging tool and/or any other component of the residue manager assembly to be performed without human intervention.

It is to be understood that the steps of the method 300 are performed by the computing system upon loading and executing software code or instructions that are tangibly stored on a tangible computer-readable medium, such as on a magnetic medium, e.g., a computer hard drive, an optical medium, e.g., an optical disk, solid-state memory, e.g., flash memory, or other storage media known in the art. Thus, any of the functionality performed by the computing system described herein, such as the method 300, is implemented in software code or instructions which are tangibly stored on a tangible computer-readable medium. The computing system loads the software code or instructions via a direct interface with the computer-readable medium or via a wired and/or wireless network. Upon loading and executing such software code or instructions by the computing system, the computing system may perform any of the functionality of the computing system described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for an agricultural harvester, the system comprising:
a material processing system configured to receive a flow of harvested materials;
a first sensor assembly operably coupled with the material processing system and configured to capture data associated with a first mass flow rate;
a second sensor assembly operably coupled with the material processing system and configured to capture data associated with a second mass flow rate; and
a computing system communicatively coupled to the first sensor assembly and the second sensor assembly, the computing system configured to:
determine the first mass flow rate of the flow of the harvested materials through the material processing system based at least in part on the data received from the first sensor assembly;
determine the second mass flow rate of the flow of the harvested materials through the material processing system based at least in part on the data received from the second sensor assembly; and
determine an error between the first mass flow rate and the second mass flow rate.

2. The system of claim 1, wherein the computing system is further configured to:
compare the error to a predefined threshold; and
initiate a control action based at least in part on the error exceeding the predefined threshold.

3. The system of claim 2, wherein the control action comprises at least one of:
causing data associated with the first mass flow rate to be presented to an operator via a user interface of the agricultural harvester;
generating a yield map based at least in part on the first mass flow rate; or
automatically controlling an operation of a component of the agricultural harvester based at least in part on the first mass flow rate.

4. The system of claim 1, wherein the first sensor assembly is positioned downstream of the second sensor assembly within the material processing system.

5. The system of claim 1, wherein the computing system is further configured to:
compare the error to a predefined threshold; and
determine an error factor to recalibrate the first mass flow rate based at least in part on the second mass flow rate.

6. The system of claim 1, wherein the second sensor assembly comprises:
one or more mass sensors configured to capture data indicative of a mass of the harvested materials with a defined space.

7. The system of claim 1, wherein the second sensor assembly comprises:
a first sensor configured to capture data indicative of a volume of the flow of the harvested materials being directed through the material processing system; and
a second sensor configured to capture data indicative of a density of the flow of the harvested materials being directed through the material processing system.

8. The system of claim 7, wherein the material processing system comprises:
a feed roller assembly including a plurality of top rollers and a plurality of bottom rollers, with the flow of the harvested materials being directed along a flow path defined between the plurality of top rollers and the plurality of bottom rollers; and
the first sensor is configured to detect a parameter associated with a distance defined between a first roller of the plurality of top rollers and a second roller of the plurality of bottom rollers, the distance being indicative of the volume of the flow of the harvested materials directed through the material processing system.

9. The system of claim 7, wherein the material processing system comprises:
a chopper assembly configured to receive and process the flow of the harvested materials; and
the second sensor is configured to detect a pressure associated with an operation of the chopper assembly, the pressure being indicative of the density of the flow of the harvested materials directed through the material processing system.

10. The system of claim 9, wherein the pressure comprises a fluid pressure associated with rotationally driving one or more chopper drums of the chopper assembly.

11. A method for operating an agricultural harvester, the agricultural harvester including a material processing system configured to receive a flow of harvested materials, the method comprising:
determining, with a computing system, a first mass flow rate of the flow of the harvested materials directed through the material processing system based on data received from a first sensor assembly;
determining, with the computing system, a second mass flow rate of the flow of the harvested materials directed through the material processing system based on data received from a second sensor assembly; and
determining an error between the first mass flow rate of the flow of the harvested materials and the second mass flow rate of the flow of the harvested materials.

12. The method of claim 11, wherein the first sensor assembly provides data indicative of a mass of the harvested materials along an elevator within the material processing system.

13. The method of claim 11, wherein the second sensor assembly provides data indicative of a volume of the flow of the harvested materials being directed through the material processing system and data indicative of a density of the flow of the harvested materials being directed through the material processing system.

14. The method of claim 11, further comprising:
initiating, with the computing system, a control action in response to the error exceeding a predefined threshold.

15. The method of claim 14, wherein initiating the control action comprises causing data associated with the first mass flow rate to be presented to an operator via a user interface of the agricultural harvester.

16. The method of claim 14, wherein initiating the control action comprises generating a yield map based at least in part on the first mass flow rate.

17. The method of claim 15, wherein initiating the control action comprises automatically controlling an operation of a component of the agricultural harvester based at least in part on the first mass flow rate.

18. A system for an agricultural harvester, the system comprising:
a material processing system configured to receive a flow of harvested materials;
a first sensor assembly operably coupled with the material processing system and configured to capture data associated with a first mass flow rate;
a second sensor assembly operably coupled with the material processing system and configured to capture data associated with a second mass flow rate; and
a computing system communicatively coupled to the first sensor assembly and the second sensor assembly, the computing system configured to:
determine the first mass flow rate of the flow of the harvested materials through the material processing system based at least in part on the data received from the first sensor assembly;
determine the second mass flow rate of the flow of the harvested materials through the material processing system based at least in part on the data received from the second sensor assembly;
determine an error between the first mass flow rate and the second mass flow rate; and
determine a first factor for correlating the second mass flow rate to the first mass flow rate during a calibration process.

19. The system of claim 18, wherein the computing system is further configured to:
compare the error to a predefined threshold during a monitoring process after the calibration process; and
initiate a control action based at least in part on the error exceeding the predefined threshold.

20. The system of claim 19, wherein the computing system is further configured to:
determine a second factor for correlating the first mass flow rate to the second mass flow rate during a recalibration process after the error exceeds the predefined threshold.
